(19) United States
(12) Patent Application Publication
(10) Pub. No.: US 2019/0329442 A1
(43) Pub. Date: Oct. 31, 2019

(54) THERMALLY MODIFIED WOOD PRODUCT AND A PROCESS FOR PRODUCING SAID PRODUCT

(71) Applicant: Stora Enso OYJ, Helsinki (FI)

(72) Inventor: Björn Källander, Djurås (SE)

(73) Assignee: Stora Enso OYJ, Helsinki (FI)

(21) Appl. No.: 16/310,159

(22) PCT Filed: Jun. 14, 2017
(86) PCT No.: PCT/IB2017/053522

§ 371 Date: Dec. 14, 2018

(30) Foreign Application Priority Data
Jun. 15, 2016 (SE) 1650839-2

(51) Int. Cl. B27K 5/00; B27K 3/02

(52) U.S. Cl. CPC B27K 5/009; F26B 2210/16; B27K 3/0214

(57) ABSTRACT

The present invention relates to a process for preparing a modified wood product. More specifically, the invention relates to a method of performing thermal modification, wherein the thermally modified wood is suitable for load bearing use. The present invention also relates to a modified wood product produced using said process.

### FIELD OF THE INVENTION

The present invention relates to a process for preparing a modified wood product. More specifically, the invention relates to a method of performing thermal modification, wherein the thermally modified wood is suitable for load bearing use. The present invention also relates to a modified wood product produced using said process.

### BACKGROUND

Many wood species are susceptible to damage caused by the external environment. Untreated wood that is exposed to moisture and/or soil for sustainable periods of time will become weakened by attacks from various types of microorganisms or insects. It is therefore of importance to treat the less durable wood in order to increase its resistance against moisture and fungal attack.

There exist a number of different treatment methods which will increase the resistance against biological decay of wood. Chemical treatments of wood in order to increase the biological durability and strength have been used for a long time. Many different chemicals may be added.

These chemicals are normally called fungicides and they will provide long-term resistance to organisms that cause deterioration of the wood. If it is applied correctly, it can extend the productive life of timber by five to ten times.

Another known method to improve the resistance of wood is to treat the wood at high temperatures to thermally modify the wood. The most common method is the Thermowood process, in which the wood is treated with superheated steam at atmospheric pressure. The wood is dried to absolute dryness at a temperature of up to approximately 130° C., followed by a temperature increase to the temperatures required for obtaining the modification, commonly 190° C. to 212° C.

Thermal modification reduces the hygroscopicity of the wood, leading to a lower Equilibrium Moisture Content (EMC). Resistance to biological decay is improved by a combination of reduced EMC which reduces moisture available for fungus, and chemical changes that decreases the possibility for fungi and bacteria to thrive on the wood. The reduction in EMC also improves the dimensional stability of the wood with less shrinkage and swelling as result. One downside of thermally modified wood is the reduction in strength. Bending strength and surface hardness are reduced, and the wood becomes more brittle, as a result of the modification process.

Because of the reduced strength of wood that has been thermally modified according to the established standard procedures, such wood is not recommended for load bearing purposes.

There have been several attempts at reducing the negative influence of thermal modification on the strength properties, although with little to no success. In the Plato process, the heat treatment is performed in two separate steps, with a first treatment in hot water under elevated pressure, followed by drying to absolute dryness followed by treatment of the wood in superheated steam at a high temperature.

It has also been suggested to do the actual thermal modification at other pressures than atmospheric. Examples of such methods are for instance the Firmolin process in which the wood is treated in steam under elevated pressure. By treating the wood under elevated pressure, chemical changes such as hydrolysis are initiated at lower temperatures than atmospheric pressure. An opposite attempt is the recently developed Termovuoto process in which the wood is treated under reduced pressure or vacuum.

In view of the limited success of the state of the art processes, there is a need for an improved modified wood product that does not suffer from the reduced bending strength traditionally associated with thermally modified wood.

### SUMMARY OF THE INVENTION

It has surprisingly been found that by removing water from the wood at a relatively low temperature, prior to exposing the wood to the elevated temperatures required for modification of the wood, the undesirable reduction of bending strength can be minimized and the treated wood can even be suitable for load bearing purposes.

One object of the invention is thus to provide thermally modified solid wood which is suitable for load bearing purposes.

Another object of the present invention is to provide a process for producing said modified wood in an efficient way.

These objects and other advantages are achieved by the process and the product according to the independent claims.

One embodiment of the present invention is thermally modified solid wood which is suitable for load bearing purposes. In one embodiment of the present invention, pine or spruce wood is used.

One embodiment of the present invention is thermally modified solid wood having a characteristic bending strength of at least 18 N/mm² measured according to EN408:2010 “Timber Structures. Structural Timber and Glued Laminated Timber. Determination of some Physical and Mechanical Properties.” The characteristic bending strength is the 5-percentile value for the population concerned.

One embodiment of the present invention is thermally modified solid wood which is suitable for load bearing purposes above ground in accordance with Use Class 3.1 as described in the European standard EN335:2013 “Wood Preservatives. Test Method for Determining the Protective Effectiveness against Wood Destroying Basidiomycetes,”

The present invention also relates to a process for preparing thermally modified solid wood, wherein the wood is dried to an average moisture content of less than 5% at an average wood temperature of less than 100° C., followed by an increase in wood temperature to above 140° C. Average moisture content can be determined using methods known in the art. In one embodiment of the present invention, the wood is dried to an average moisture content of less than 4% at an average wood temperature of less than 100° C., followed by an increase in wood temperature to above 140° C. In one embodiment of the present invention, the wood is dried to an average moisture content of less than 3% at an average wood temperature of less than 100° C., followed by an increase in wood temperature to above 140° C.

In one embodiment of the present invention, the drying is performed in a mixture of air, steam and other gases, or entirely in steam or in a fluid such as water or oil.

In one embodiment of the present invention, the drying takes place under reduced pressure. In one embodiment of the present invention, the drying is performed under vacuum or near vacuum. In one embodiment of the present invention, the drying is performed under elevated pressure. In one embodiment, the drying is performed at an absolute pressure below 1013 mBar. In one embodiment, the drying is performed at an absolute pressure above 1013 mBar. In one embodiment, the drying is performed at an absolute pressure of approximately 1013 mBar.

In one embodiment of the present invention, the energy for the drying is transferred to the wood through convection by circulating air, steam, gas, liquid or mixtures of these media.

In one embodiment of the present invention, the energy for the drying is transferred to the wood through heat from a hot material in contact with the wood or through dielectric heating such as high frequency heating using radio waves or microwaves.

In one embodiment of the present invention, the treated wood is softwood. In one embodiment of the present invention, the treated wood is hardwood. In one embodiment of the present invention, the wood is from Pinus sylvestris. In one embodiment of the present invention, the wood is from Picea abies.

In one embodiment of the present invention, the wood to be treated is sorted prior to the heat treatment step and wood or planks with certain characteristics or properties are included or excluded from the treatment according to the present invention.

In one embodiment of the present invention, the wood treated in accordance with the present invention has been found to be of strength class C18 or higher according to the European standard EN338:2016 “Structural timber—strength classes” prior to treatment.

In one embodiment of the present invention, the wood treated in accordance with the present invention has been found to be of strength class C22 or higher according to the European standard EN338:2016 “Structural timber—strength classes” prior to treatment.

In one embodiment of the present invention, the boards treated in accordance with the present invention has a minimum local stiffness, prior to treatment, of at least 10 N/mm² when being bent on its flat side.

In one embodiment of the present invention, the wood treated in accordance with the present invention has a dynamic e-modulus, prior to treatment, of at least 10 N/mm².

### BRIEF DESCRIPTION OF THE FIGURES

FIG. 1. Normal schedule for treatment of Thermowood D.

FIG. 2. Special treatment schedule according to the present invention. Wood is pre dried at low temperature.

FIG. 3. Stiffness and bending strength determined according to EN 408 of untreated planks, planks treated according to normal Thermowood D schedule, and planks treated according to a special schedule based on the invention.

### DETAILED DESCRIPTION

The bending strength of wood, such as the thermally modified wood according to the present invention, can be measured using methods known in the art. In particular, the bending strength of dimensional lumber can be measured according to EN408 Timber structures—Structural timber and glued laminated timber—Determination of some physical and mechanical properties. Results from tests according to EN 408 are used to determine characteristic values according to European standard EN 384 Structural timber—Determination of characteristic values of mechanical properties and density. Requirements for different strength classes are defined in European standard EN 338 Structural timber—Strength classes. All of which are standards recognized by a person skilled in the art.

Thermal modification according to the present invention can be done on pre dried wood as well as green, unseasoned, wood. The initial moisture content of the wood used in the process according to the present invention is typically at least 10%. In one embodiment of the present invention, the moisture content is from 10% to 20%. In a further embodiment, the moisture content is from 11% to 15%, such as from 12% to 14%. In a further embodiment, the moisture content is about 12%. In one embodiment, the moisture content is close to the fiber saturation point. The moisture content as well as the fiber saturation point of wood can be determined using methods known in the art.

The time required for the drying step depends on the properties of the wood used, but is generally in the range of from 5 hours to 96 hours for softwood.

During the thermal modification step, the wood is heated at a temperature of from 160° C. to 250° C. at atmospheric pressure or at a temperature of from 120° C. to 250° C. at a pressure higher than atmospheric pressure.

In one embodiment of the present invention, the wood may be densified during or after the thermal modification step. The densification may be done by applying pressure to the wood. The densification may be done at a pressure of 1-3 kg/cm² and the maximum compression should be about 10% of the thickness of the wood.

For densification, it is preferred to apply both pressure and heat, since this combination will improve the densification of the wood. The densification may be done off-line, on-line or in-line, i.e. in-line with the process according to the invention. If off-line densification is used, it is possible to use a hot press after the thermal modification step. If in-line densification is used it is possible to use roller or plate based systems. The densification can be done during the thermal modification step or after the thermal modification step.

By densifying the wood, the surface of the wood will become more set, i.e. the fibers on the surface have less tendency to react with moisture and retain its original form. This also leads to reduced tendency of fiber loosening on the surface of the wood. The surface density and thus also the hardness of the wood will also be improved.

The produced thermally modified wood can also be used for load bearing purposes.

The term “solid wood” as used herein is defined as a solid wood component of any kind of wood species, including finger jointed as well as laminated products.

The produced thermally modified wood product can be used for the production of many different products, such as cladding, decking, window and door profiles, light poles, jetties, joinery, furniture etc.

### EXAMPLES

### Thermal Treatment of the Material

Saw falling 45×145 mm Norway spruce planks were heat treated according to a standard Thermowood D schedule and according to a special schedule according to the present invention. Both schedules used a 3 h plateau phase at temperature of 212° C. One set of planks from the same batch was kept untreated to be used as reference material.

### Standard Thermowood Treatment

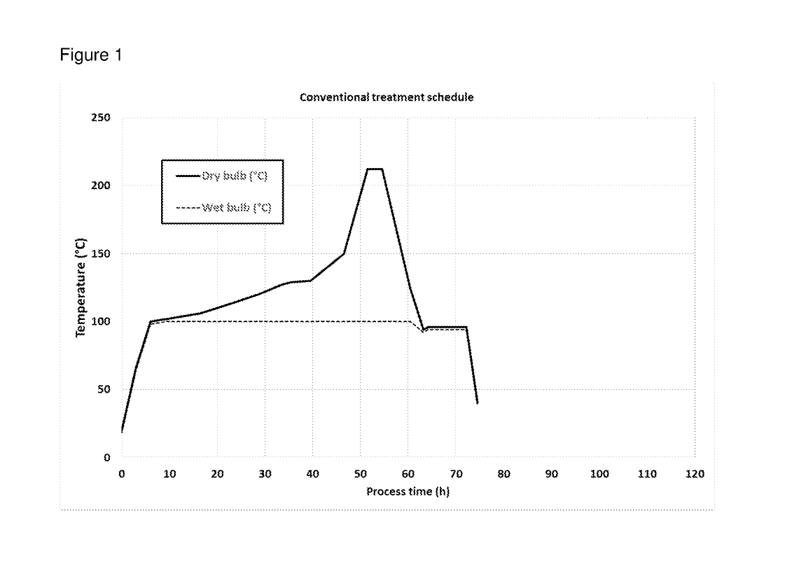

The standard Thermowood D schedule was designed as shown in FIG. 1. The 77 h schedule comprises of initial heating to 100° C., drying phase at increased temperature up to 130° C., heating to plateau temperature, 3 h treatment at 212° C., cooling, and conditioning.

The climate at the end of HT-drying phase at 130° C. dry bulb temperature and 99° C. wet bulb temperature corresponds to Equilibrium Moisture Content (EMC)=1% to 2.5%.

### Special Treatment According to the Present Invention

The special treatment schedule is based on the idea to reduce or eliminate hydrolysis of the material by drying it to very low MC at low temperature. Drying is done at 90° C. dry bulb temperature with wet bulb temperature gradually reduced to 50° C., corresponding to EMC 2.5%.

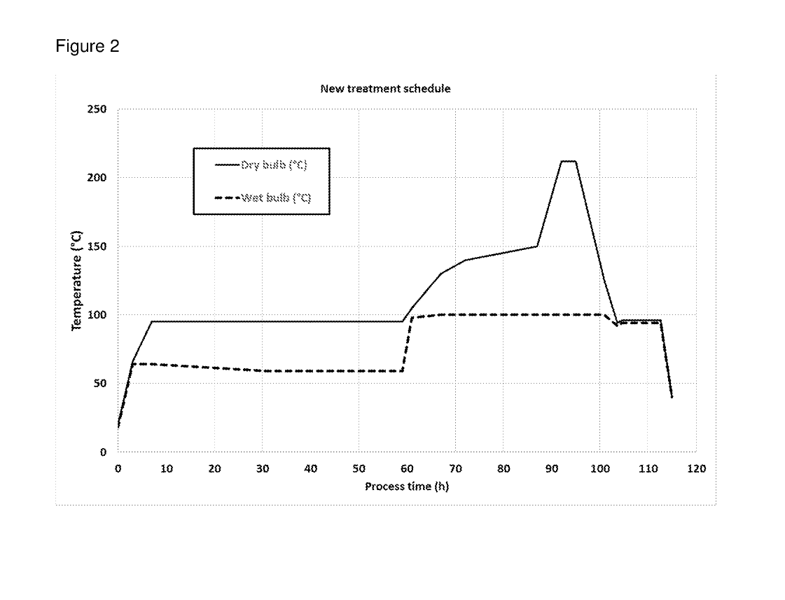

The low temperature drying phase in the test was 52.5 h, followed by a 28 h HT-drying phase before temperature was increased up to 212° C. FIG. 2 shows the trend curves from the special treatment.

Results from Bending Tests

The results from the bending strength tests are summarized in Table 1. Critical values for approval for load bearing use are marked with bold text.

TABLE 1
Summary of test results from EN 408 bending tests

| | | | | Thermowood |
|---|---|---|---|---|
| | | | Normal | according to |
| | | Untreated | Thermowood | present |
| Tested property | Unit | reference | D | invention |
| Bending strength | N/mm² | 45.2 | 32.5 | 36.9 |
| 4-points edgewise | | | | |
| Strength standard | N/mm² | 9.6 | 10.7 | 12.2 |
| deviation | | | | |
| Characteristic | N/mm² | 28.0 | 15.2 | 19.6 |
| bending strength | | | | |
| Number of planks | n | 22 | 77 | 75 |
| tested | | | | |
| Stiffness | N/mm² | 9.8 | 10.1 | 10.6 |
| Global E-modulus | | | | |
| E-mod standard | N/mm² | 1.8 | 1.8 | 1.9 |
| deviation | | | | |
| Number of planks | n | 22 | 71 | 73 |
| tested | | | | |

The test results show that strength values can be further improved by pre-sorting of the raw material prior to treatment. Table 2 shows strength values obtained after removal of planks with low local initial stiffness determined mechanically by a Metriguard longitudinal machine stress rating equipment:

TABLE 2
Test results from EN 408 bending tests with low stiffness planks
removed.

| | | | Normal | Improved |
|---|---|---|---|---|
| | | Untreated | Thermowood | Thermowood |
| Tested property | Unit | reference | D | D |
| Bending strength | N/mm² | 49.0 | 34.4 | 39.0 |
| 4-points edgewise | | | | |
| Strength standard | N/mm² | 9.6 | 10.7 | 11.8 |
| deviation | | | | |
| Characteristic | N/mm² | 38.9 | 16.8 | 21.0 |
| bending strength | | | | |
| Number of planks | n | 16 | 30 | 32 |
| tested | | | | |
| Stiffness | N/mm² | 10.6 | 10.8 | 11.7 |
| Global E-modulus | | | | |
| E-mod standard | N/mm² | 1.1 | 1.8 | 1.8 |
| deviation | | | | |
| Number of planks | n | 16 | 27 | 32 |
| tested | | | | |

Removal of the planks with the lowest local stiffness gave a slight increase of the bending strength values.

However, the stress grading was done by mechanical bending flatwise, and the bending tests were made edgewise. By using more advanced stress grading procedures a larger increase of characteristic strength values is expected.

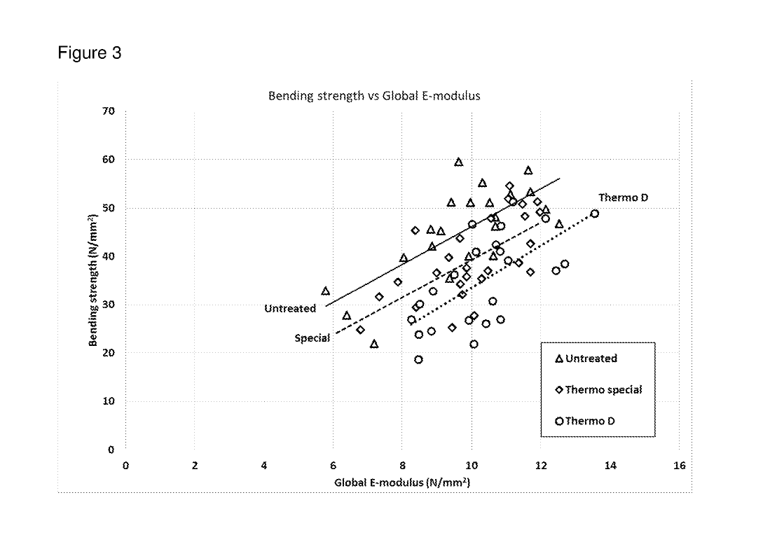

The improvement in bending strength is illustrated by the diagram in FIG. 3.

In view of the above detailed description of the present invention, other modifications and variations will become apparent to those skilled in the art. However, it should be apparent that such other modifications and variations may be effected without departing from the spirit and scope of the invention.

1. Thermally modified solid wood which is suitable for load bearing purposes.

2. Thermally modified solid wood according to claim 1, having a characteristic bending strength of at least 18 N/mm².

3. Thermally modified solid wood according to claim 2, wherein the bending strength is measured according to EN408:2010.

4. Thermally modified solid wood according to claim 1, which is suitable for load bearing purposes above ground.

5. Thermally modified solid wood according to claim 4, wherein the suitability for use above ground is defined in accordance with Use Class 3.1 as described in the European standard EN335:2013.

6. Thermally modified solid wood according to claim 1, wherein said wood is pine wood or spruce wood.

7. Process for preparing thermally modified solid wood, wherein wood is dried to an average moisture content of less than 5% at an average wood temperature of less than 100° C., followed by an increase in wood temperature to above 140° C.

8. Process according to claim 7, wherein the wood is dried to an average moisture content of less than 5% at an average wood temperature of less than 100° C., followed by an increase in wood temperature to above 160° C. at atmospheric pressure, wherein the wood is maintained at a temperature above 160° C. for at least one hour, followed by cooling to ambient temperature.

9. Process according to claim 8, wherein the wood is dried to an average moisture content of less than 5% at an average wood temperature of less than 100° C., followed by an increase in wood temperature to a temperature above 160° C. and below 250° C. at atmospheric pressure, wherein the wood is maintained at a temperature above 160° C. and below 250° C. for at least one hour, followed by cooling to ambient temperature.

10. Process according to claim 7, wherein the wood is dried to an average moisture content of less than 5% at an average wood temperature of less than 100° C., followed by an increase in wood temperature to above 120° C. at a pressure higher than atmospheric pressure, wherein the wood is maintained at a temperature above 120° C. for at least one hour, followed by cooling to ambient temperature.

11. Process according to claim 7, wherein the drying is performed at an absolute pressure below 1013 mBar.

12. Process according to claim 7, wherein the drying is performed at an absolute pressure above 1013 mBar.

13. Process according to claim 7, wherein the drying is performed at an absolute pressure of approximately 1013 mBar.

14. Thermally modified solid wood obtainable by the process according to claim 7.
